(19) United States
(12) Patent Application Publication
(10) Pub. No.: US 2017/0173939 A1
(43) Pub. Date: Jun. 22, 2017

(54) TRANSFER APPARATUS AND TRANSFER METHOD

(71) Applicant: SCREEN HOLDINGS CO., LTD., Kyoto (JP)

(72) Inventors: Itsuki KAJINO, Kyoto (JP); Kazuhiro SHOJI, Kyoto (JP); Mikio MASUICHI, Kyoto (JP)

(21) Appl. No.: 15/378,941

(22) Filed: Dec. 14, 2016

(30) Foreign Application Priority Data
Dec. 16, 2015 (JP) 2015-245359

(51) Int. Cl. B41F 16/00; B41F 3/00

(52) U.S. Cl. CPC B41F 16/00; B41F 3/00

(57) ABSTRACT

It is aimed to provide a technique enabling a roller member to press a plate body with a uniform and stable pressing force. A transfer roller 431 configured to come into contact with a blanket BL and press the blanket BL against a substrate SB is rotatably supported by a pair of supports 430 on opposite end parts thereof. Supporting angles 4334 configured to support a rotary shaft of the transfer roller 431 are supported movably upward and downward by linear guides 4332, 4333 and biased upwardly by biasing portions 434. Displacements of the supporting angles 4334 by biasing forces are restrained at a predetermined height by stoppers 435, and the posture of the transfer roller 431 (inclination of the rotary shaft) when the transfer roller 431 approaches the blanket BL from below is controlled. Restraint by the stoppers 435 is released when the blanket BL is pressed against the substrate SB and a constant pressing force is applied to the blanket BL by the biasing forces.

### CROSS REFERENCE TO RELATED APPLICATION

The disclosure of Japanese Patent Application No. 2015-245359 filed on Dec. 16, 2015 including specification, drawings and claims is incorporated herein by reference in its entirety.

### BACKGROUND OF THE INVENTION

1. Field of the Invention

This invention relates to a transfer technique for transferring an object to be transferred from one plate body to another plate body by bringing two plate bodies into contact.

2. Description of the Related Art

As a technique for forming a pattern or thin film on a plate body such as a glass substrate or semiconductor substrate, a technique for transferring an object to be transferred such as a pattern or thin film carried on a principal surface of one plate body to another plate body by bringing two plate bodies into contact with each other is known. One method of this is to bring two plate bodies into close contact and transfer an object to be transferred by pressing one of the two plate bodies arranged to proximately face each other across the object to be transferred by a roller (see, for example, JP2014-184716A). In this technique, a roller member rotatably supported on both ends is caused to travel along the plate body while being pressed against the plate body, whereby the plate bodies are brought into close contact by a pressing force acting between the plate bodies.

Such a transfer technique is similar to a printing technique and a technical concept of the printing technique can be applied in some cases. For example, it is considered to apply a printing technique described in JP2010-280085A to control a pressing force by the roller to a proper value in the conventional technique described above. In this technique, a blanket roll is provided movably upward and downward with respect to a horizontal plate table and the blanket roll is biased toward the plate table in order to bring a printing plate and the blanket roll into contact with a suitable contact pressure. After the blanket roll comes into contact with a margin part of an end part of the plate with a relatively low contact pressure, a pressure is detected and a height of the blanket roll is adjusted to control a pressure when the blanket roll comes into contact with a printing pattern area of the plate.

In this technique, since the blanket roll is biased in a direction toward the plate, even if a plate surface is undulating, a variation of a pressing force can be suppressed by the blanket roll moving upward and downward, following the undulation. Such a function is expected to be effective also in the transfer technique described above.

For example, in a transfer technique intended to manufacture an electronic device, required transfer position accuracy is higher than accuracy generally required in the printing technique. Thus, it is not appropriate in some cases to simply apply the printing technique as it is. For example, in the transfer technique previously disclosed in JP2014-184716A by the applicant of this application, it is known that a position deviation when two plate bodies first come into contact largely affect the overall transfer position accuracy. Further, it is known that, in order to prevent a transfer failure and a positional deviation due to nonuniform pressing, parallelism between a roller member and a plate body when the roller member first comes into contact with the plate body needs to be maintained. For these purposes, the conventional technique for adjusting a pressure ex post facto after two objects are brought into contact as described above cannot be necessarily said to be appropriate.

As just described, in a transfer technique for pressing two plate bodies held in close contact by a roller member as in the above conventional technique, there is a need to more uniformly and stably press the plate body by the roller member to improve transfer performance. However, there is a problem that a technique capable of responding to such a need has not been sufficiently established yet.

### SUMMARY OF THE INVENTION

This invention was developed in view of the above problem and an object thereof is to provide a technique enabling a roller member to press a plate body with a uniform and stable pressing force in a transfer apparatus and a transfer method for bringing two plate bodies by pressing by the roller member.

To achieve the above object, one aspect of this invention is directed to a transfer apparatus with a first holder configured to hold a first plate body in a horizontal posture with a lower surface open, a second holder configured to hold a second plate body with an upper surface of the second plate body proximately facing the lower surface of the first plate body and with a lower surface of a central part of the second plate body open, where the central part of the second plate body is facing the first plate body at the upper surface side, by holding a peripheral edge part of the second plate body, and a presser configured to press the second plate body against the first plate body by pushing up the central part of the second plate body.

Here, the presser includes a roller member extending in an axial direction along the lower surface of the second plate body, an elevating member provided with a pair of supports for supporting opposite end parts of the roller member in an axial direction, an elevating mechanism which raises and lowers the elevating member, thereby moves the roller member between a pressing position where an upper end of the roller member comes into contact with the second plate body to press the second plate body against the first plate body and a separated position where the roller member is separated from the second plate body, and a traveling mechanism configured to move the elevating member in a traveling direction parallel to the lower surface of the second plate body and orthogonal to a rotary shaft of the roller member.

Each of the supports includes a bearing mechanism configured to rotatably support one end part of the roller member, a biasing mechanism configured to bias the bearing mechanism toward the second plate body and a restraining member configured to restrict a displacement of the bearing mechanism by a biasing force to a predetermined restrained position.

In the thus configured invention, the roller member is pressed against the second plate body while being biased toward the second plate body by the pair of supports respectively provided to correspond to the opposite end parts of the roller member. Thus, even if the lower surface of the second plate body is undulating, for example, due to processing accuracy of the first plate body, the second plate body, the first holder, the second holder and the like, the roller member can stably press the second plate body by moving, following the undulation of the lower surface. Note that the “central part of the second plate body” means the lower surface of a relatively wide part on an inner part of the second plate body excluding the peripheral edge part held by the second holder and is not a concept indicating, for example, a geometric center or centroid of a shape or a limited area near the geometric center or centroid.

On the other hand, unless the posture of the roller member supported with biasing forces given in this way is not properly controlled when the roller member is separated from the second plate body, parallelism between the roller member and the second plate body is not guaranteed. If the roller member comes into contact with the second plate body from a state where parallelism is not maintained, one end part closer to the second plate body out of the opposite end parts of the upper end of the roller member in the axial direction comes into contact with the second plate body earlier than the other end part, wherefore uniform contact cannot be obtained. If the roller member pushes up the second plate body in such a nonuniform contact state, local deformation or positional deviation of the second plate body may occur.

Accordingly, in the invention, the restraining member comes into contact with the bearing mechanism of the roller member about to be displaced toward the second plate body by being biased, whereby the bearing mechanism is prevented from being displaced toward the second plate body beyond the restrained position. This enables a control of the posture of the roller member separated from the second plate body, more specifically, a position of an upper end of the roller member. Thus, the roller member can be brought into contact with the second plate body with parallelism between the roller member and the second plate body maintained by controlling the posture of the roller member before contact with the second plate body. As a result, a pressing force to the second plate body becomes uniform in the axial direction of the roller member and local deformation and positional deviation of the second plate body can be suppressed.

As just described, according to the present invention, the roller member biased in a direction toward the second plate body and having the posture controlled in a state separated from the second plate body comes into contact with the second plate body to press the second plate body against the first plate body. This enables a stable pressing force to act between the first plate body and the second plate body. Particularly, the pressing force can be made uniform in the axial direction in an initial stage of contact of the roller member with the second plate body. Thus, local deformation and positional deviation of the second plate body due to nonuniform pressing can be prevented.

Further, another aspect of this invention is directed to a transfer method for bringing a first plate body and a second plate body into close contact and transferring an object to be transferred carried on the one plate body to the other plate body and, in order to achieve the above object, the transfer method includes arranging the first and second plate bodies in a horizontal posture by causing the first and second plate bodies to proximately face each other across the object to be transferred, bringing a roller member having opposite end parts respectively rotatably supported by a pair of supports and biased toward the second plate body into contact with a lower surface of the second plate body by approaching the second plate body from below the second plate body, and causing the roller member to travel in a traveling direction parallel to the lower surface of the second plate body and orthogonal to a rotary shaft of the roller member while pressing the second plate body against the first plate body. Further, restraining members provided in the respective supports restricting a displacement of the roller member caused by biasing forces, thereby making an upper end of the roller member parallel to the lower surface of the second plate body when the roller member comes into contact with the second plate body.

In the thus configured invention, similarly to the invention of the transfer apparatus described above, the roller member biased in a direction toward the second plate body by the pair of supports comes into contact with the lower surface of the second plate body. Thus, even if the lower surface of the second plate body is undulating, the roller member follows. Therefore, a stable pressing force can be caused to act between the first and second plate bodies. The posture of the roller member separated from the second plate body is controlled by restraint by the restraining members. Thus, the roller member can be brought into contact with the second plate body with the upper end of the roller member held parallel to the lower surface of the second plate body. As a result, local deformation and positional deviation of the second plate body due to nonuniform pressing can be prevented by making the pressing force uniform in the axial direction particularly in an initial stage of contact of the roller member with the second plate body.

As described above, according to the invention, the roller member biased in the direction toward the second plate body and having the posture controlled in the state separated from the second plate body comes into contact with the second plate body to press the second plate body against the first plate body. By doing so, a stable pressing force can be caused to act between the first and second plate bodies.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a side view schematically showing one embodiment of a transfer apparatus according to this invention.

FIG. 2 is a diagram showing the configuration of a main part of this transfer apparatus.

FIG. 3 is a perspective view showing the configuration of the transfer roller block.

FIGS. 4A and 4B are front views showing the configuration of the transfer roller block.

FIGS. 5A and 5B are side views showing the configuration of the transfer roller block.

FIG. 6 is a flow chart showing the transfer process by this transfer apparatus.

FIGS. 7A to 7D are diagrams schematically showing the position of each component in the process of the transfer process.

FIGS. 8A to 8C are diagrams showing the operation until the transfer roller comes into contact with the blanket.

FIGS. 9A to 9C are diagrams showing a state where the transfer roller presses the blanket against the substrate.

FIG. 10 is a timing chart showing the operation of each component.

FIGS. 11A to 11C are diagrams showing positional relationships of each component before and after the alignment adjustment.

FIGS. 12A to 12C are diagrams illustrating states of deflection of the blanket on the lower stage.

### DETAILED DESCRIPTION OF THE PREFERRED EMBODIMENTS

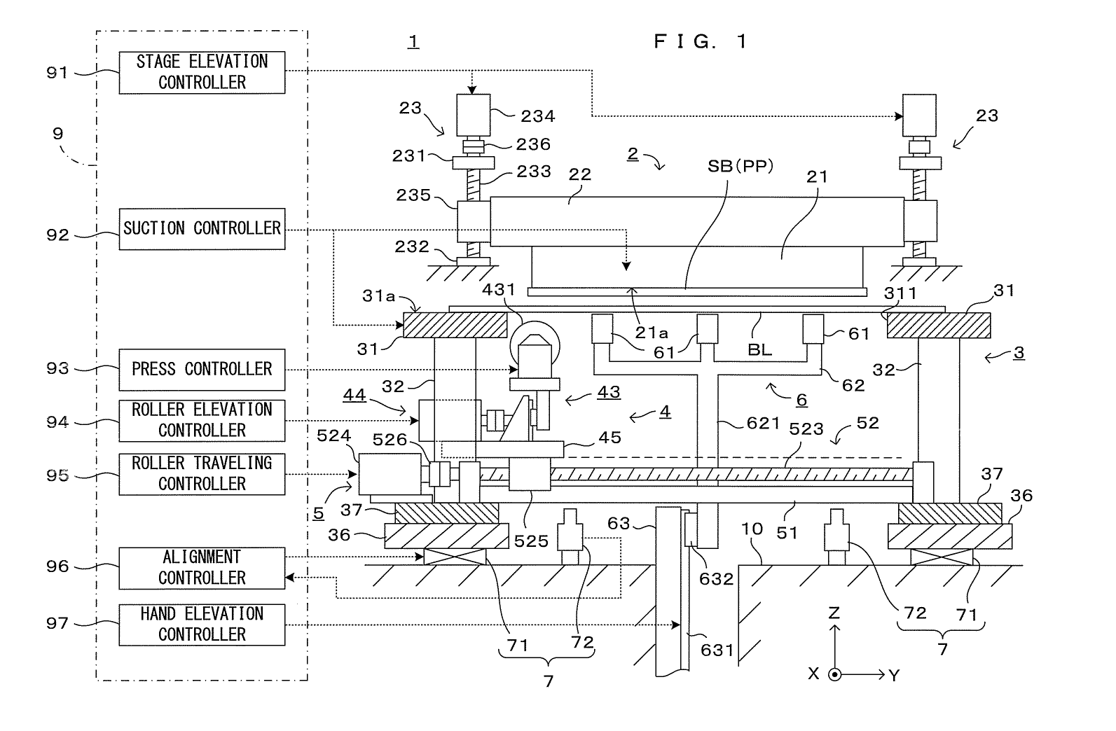

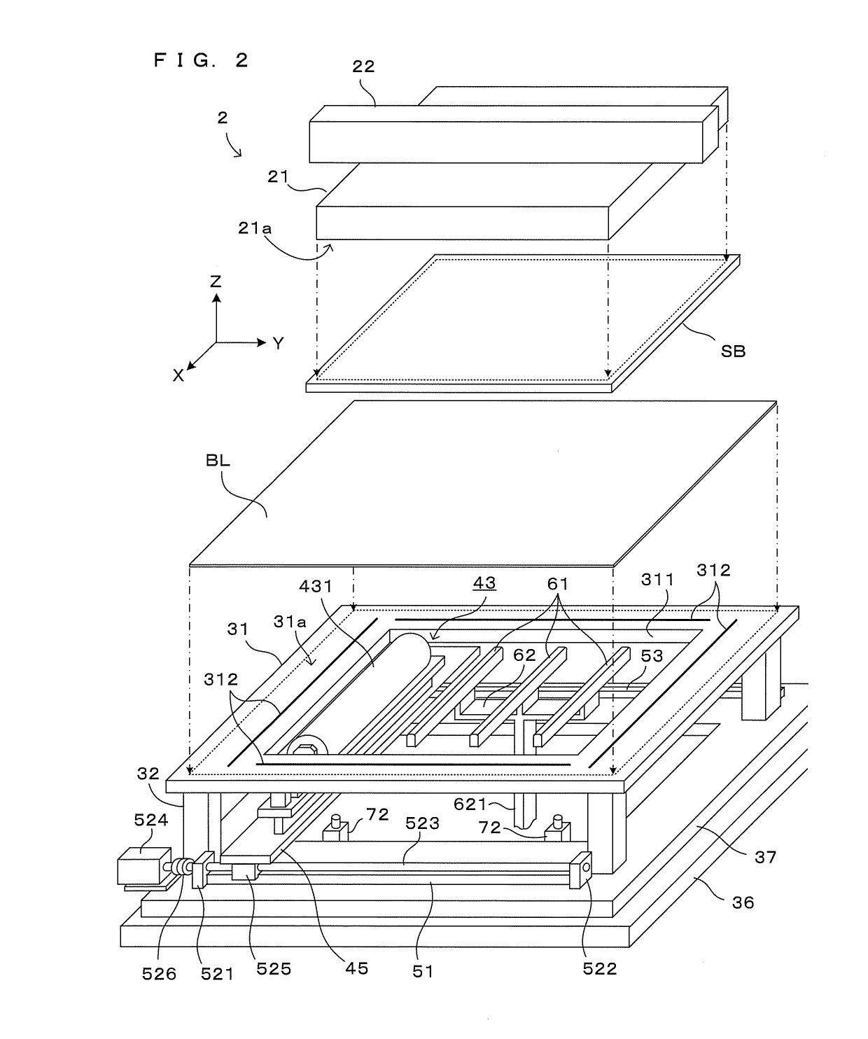

FIG. 1 is a side view schematically showing one embodiment of a transfer apparatus according to this invention. Further, FIG. 2 is a diagram showing the configuration of a main part of this transfer apparatus. XYZ orthogonal coordinate axes are set as shown in FIG. 1 to comprehensively show directions in each figure. Here, an XY plane represents a horizontal plane. Further, a Z axis represents a vertical axis, more specifically, a (−Z) direction represents a vertically downward direction.

This transfer apparatus 1 is structured such that an upper stage block 2, a lower stage block 3, a transfer roller block 4, a roller travel driver 5, a supporting hand unit 6 and an alignment unit 7 are arranged on a main frame 10. Further, besides the above, the transfer apparatus 1 includes a control unit 9 for performing a predetermined operation by controlling each component of the apparatus in accordance with a processing program stored in advance.

First, the overall configuration of the apparatus 1 is described. Note that the configurations of the upper stage block 2 and the lower stage block 3 correspond to partial modifications of corresponding configurations described, for example, in the above literature (JP2014-184716A). Accordingly, basic description of these block configurations is omitted.

The transfer apparatus 1 is a device for forming a pattern by bringing a blanket BL held by the lower stage block 3 and a plate PP or substrate SB held by the upper stage block 2 into contact with each other. A pattern formation process by this apparatus 1 is, more specifically, as follows. First, a coating layer carried on the blanket BL is patterned (patterning process) by bringing the plate PP prepared to correspond to a pattern to be formed into contact with the blanket BL having a pattern forming material evenly applied thereto. By bringing the thus patterned blanket BL and the substrate SB into contact, the pattern carried on the blanket BL is transferred to the substrate SB (transfer process). In this way, a desired pattern is formed on the substrate SB.

As just described, this transfer apparatus 1 can be used in both the patterning process and the transfer process in the pattern formation process for forming a predetermined pattern on the substrate SB. Note that this apparatus may be used to be in charge of only one of these processes. Further, this apparatus is usable for the purpose of transferring a thin film carried on the blanket BL to the substrate SB. The configuration and operation of the apparatus are described below, assuming the transfer process of transferring a pattern or thin film formed on a surface of the blanket BL to the substrate SB. However, by replacing the substrate SB by the plate PP, an operation in the patterning process is also described.

The upper stage block 2 includes an upper stage 21 whose flat lower surface serves as a substrate holding surface 21a. The upper stage 21 is attached to a lower part of a beam member 22 extending in a Y direction and held by the beam member 22 such that the substrate holding surface 21a is in a horizontal posture. The beam member 22 is held movably upward and downward along the vertical direction (Z direction) by a pair of stage elevating mechanisms 23, 23 arranged at a distance in the Y direction. In this way, the upper stage 21 is movable in the Z direction.

Although a ball screw mechanism is used as an example of the stage elevating mechanism 23 in this embodiment, there is no limitation to this. The stage elevating mechanism 23 includes a ball screw 233 rotatably supported relative to the main frame 10 by supporting members 231, 232, a motor 234 for rotating the ball screw 233 and a nut portion 235 mounted on the ball screw 233. The ball screw 233 and the motor 234 are coupled via a coupling 236. The motor 234 is connected to a stage elevation controller 91 provided in the control unit 9. The motor 234 rotates in response to a control signal from the stage elevation controller 91, whereby the upper stage 21 is raised and lowered.

Although not shown in figures, the lower surface (substrate holding surface) 21a of the upper stage 21 is provided with suction grooves or suction holes. The suction grooves or suction holes are connected to a suction controller 92 provided in the control unit 9. If necessary, a negative pressure is supplied to the suction grooves or suction holes from the suction controller 92. In this way, the upper stage 21 can suck and hold the upper surface of the substrate SB held in contact with the substrate holding surface 21a. A planar size of the substrate holding surface 21a is slightly smaller than the size of the substrate SB to be held.

The substrate SB is held in a horizontal posture by the upper stage block 2 thus configured. The substrate SB is carried into the apparatus 1 such that a transfer surface, to which a pattern or thin film is to be transferred, is faced down, and sucked and held by the upper stage 21. Further, the stage elevating mechanisms 23 raise or lower the upper stage 21, whereby a gap between the blanket BL held on a lower stage to be described next and the substrate SB is adjusted to a specified value.

The lower stage block 3 includes a lower stage 31 arranged below the upper stage 21. An opening 311 is provided in a central part of the lower stage 31, and the upper surface of the lower stage 31 serves as a flat and horizontal blanket holding surface 31a. The lower stage 31 is supported by a plurality of supporting columns 32. A planar size of the lower stage 31 is larger than the size of the blanket BL to be held and an opening size of the opening 311 is larger than a planar size of the substrate SB. The blanket BL is held on the lower stage 31 such that only a peripheral edge part thereof is in contact with the lower stage 31 and the lower surface of a central part excluding the peripheral edge part is open. Suction grooves 312 are provided in an area of the upper surface (blanket holding surface) 31a of the lower stage 31 in contact with the blanket BL. The suction grooves 312 are connected to the suction controller 92 of the control unit 9 and a negative pressure is supplied thereto from the suction controller 92 if necessary. In this way, the blanket BL is sucked and held on the lower stage 31. The blanket BL is held in a horizontal posture with a carrying surface carrying the pattern or thin film to be transferred to the substrate SB faced up.

The supporting columns 32 holding the lower stage 31 are fixed to a detachable stage 37 mounted on an alignment stage 36. Each of the alignment stage 36 and the detachable stage 37 is a metal flat plate having an opening in a center, and the detachable stage 37 has an external size slightly smaller than the alignment stage 36. The detachable stage 37 is fixed to the upper surface of the alignment stage 36 by unillustrated fixing member such as screws and integrated with the alignment stage 36. By releasing fixation if necessary, the detachable stage 37 and components mounted thereon can be integrally detached from the alignment stage 36.

The alignment stage 36 is mounted on the main frame 10 via a plurality of alignment mechanisms 71 constituting the alignment unit 7. The alignment mechanisms 71 have, for example, a cross roller bearing mechanism and moves the alignment stage 36 in a horizontal direction (XY direction) and a 0 direction about the Z axis in response to a control signal from an alignment controller 96 provided in the control unit 9. When the alignment stage 36 is moved by the alignment mechanisms 71, the detachable stage 37 and the components mounted thereon such as the lower stage 31 also integrally move with the alignment stage 36. In this way, the lower stage 31 moves within a horizontal plane (XY plane) and relative positions of the substrate SB held by the upper stage 21 and the blanket BL held by the lower stage 31 in the horizontal direction are optimized.

The alignment unit 7 includes a plurality of cameras 72. Each camera 72 is attached to the main frame 10 to face the openings of the alignment stage 36 and the detachable stage 37 with an imaging direction aligned with an upward direction. The camera 72 images alignment marks provided on each of the substrate SB and the blanket BL via the blanket BL and generates an image including the both alignment marks. The alignment controller 96 detects the amount of positional deviation between the substrate SB and the blanket BL from the positions of the alignment marks included in the image and operates the alignment mechanisms 71 in accordance with the detected amount of positional deviation, thereby aligning the substrate SB and the blanket BL. By imaging a plurality of alignment marks provided on each of the substrate SB and the blanket BL by the plurality of cameras 72 and performing an alignment, a highly accurate alignment becomes possible.

Further, the supporting hand unit 6 is mounted on the main frame 10. The supporting hand unit 6 includes a plurality of (three in this example) elevation hands 61 successively arranged along the Y direction while facing the opening 311 of the lower stage 31 and a supporting frame 62 integrally supporting these elevation hands. The respective elevation hands 61 are bar-like members extending in the X direction as a longitudinal direction and have the same shape. The upper surfaces of the respective elevation hands 61 are finished into smooth surfaces and the elevation hands 61 are mounted on the supporting frame 62 such that the heights (vertical positions) of the upper surfaces are equal among the plurality of elevation hands 61.

A lower part of the supporting frame 62 serves as a leg part 621 extending downward, and the leg part 621 is supported movably upward and downward by a hand elevation driver 63. In this example, the hand elevation driver 63 is a linear guide. Specifically, the leg part 621 is fixed to a slider 632 attached movably upward and downward to a guide rail 631 fixed to the main frame 10. The slider 632 is controlled to be driven by a hand elevation controller 97 provided in the control unit 9 and moves upward or downward in response to a control signal from the hand elevation controller 97. By doing so, the vertical positions of the respective elevation hands 61 can be collectively changed. Note that various driving mechanisms for realizing a linear movement can be used as the hand elevation driver 63. For example, a ball screw mechanism may be used.

Each elevation hand 61 is positioned at such a position that the upper surface thereof is flush with the substrate holding surface 31a of the lower stage 31. The elevation hand 61 auxiliary supports the lower surface of the central part of the blanket BL held on the lower stage 31 with the lower surface thereof open. In this way, the blanket BL can be horizontally supported to be flat while the deflection thereof is suppressed. Further, by retracting the elevation hands 61 downwardly if necessary, interference with the travel of a transfer roller to be described next is avoided.

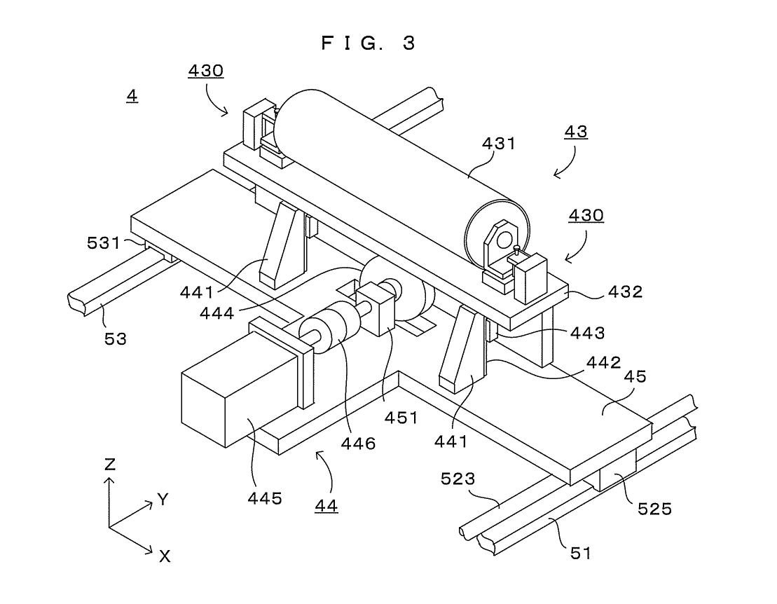

The transfer roller block 4 includes a roller unit 43 and a lifter unit 44, and these units 43, 44 are mounted on the upper surface of a plate member 45. The plate member 45 is mounted on the detachable stage 37 via the roller travel driver 5. The roller travel driver 5 includes a guide rail 51 fixed to the detachable stage 37 below a (+X) side end part of the lower stage 31 and extending in the Y direction and a ball screw mechanism 52 provided along the guide rail 51. A (+X) side end part of the plate member 45 is supported by a nut portion 525 of the ball screw mechanism 52. Further, as shown in FIG. 2, a guide rail 53 is provided on the detachable stage 37 below a (−X) side end part of the lower stage 31. A (−X) side end part of the plate member 45 is supported by a slider 531 (see FIG. 3) mounted on the guide rail 53.

In the roller travel driver 5 for supporting the transfer roller block 4, the ball screw mechanism 52 is provided along the guide rail 51. More specifically, a ball screw 523 is supported by supporting members 521, 522 provided near opposite ends of the guide rail 51 and coupled to a motor 524 via a coupling 526. The nut portion 525 is mounted on the ball screw 523. By the rotation of the motor 524, the nut portion 525 horizontally moves in the Y direction along the guide rail 51. Associated with this, the transfer roller block 4 including the plate member 45 supported by the nut portion 525 horizontally moves in the Y direction.

Note that, in FIG. 1, upper end parts of the cameras 72 and the hand elevation driver 63 appear below the guide rail 51 in order to make each component easily visible. However, in the actual apparatus, there is no problem if these positions are located below the lower surface of the plate member 45 shown by a broken line in FIG. 1.

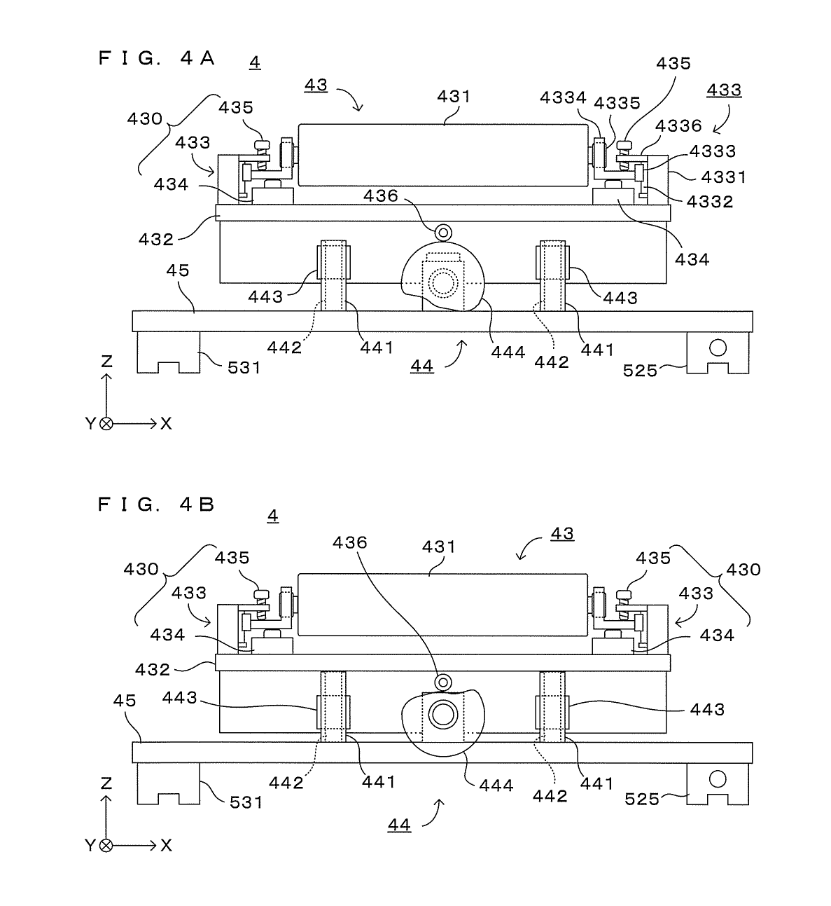

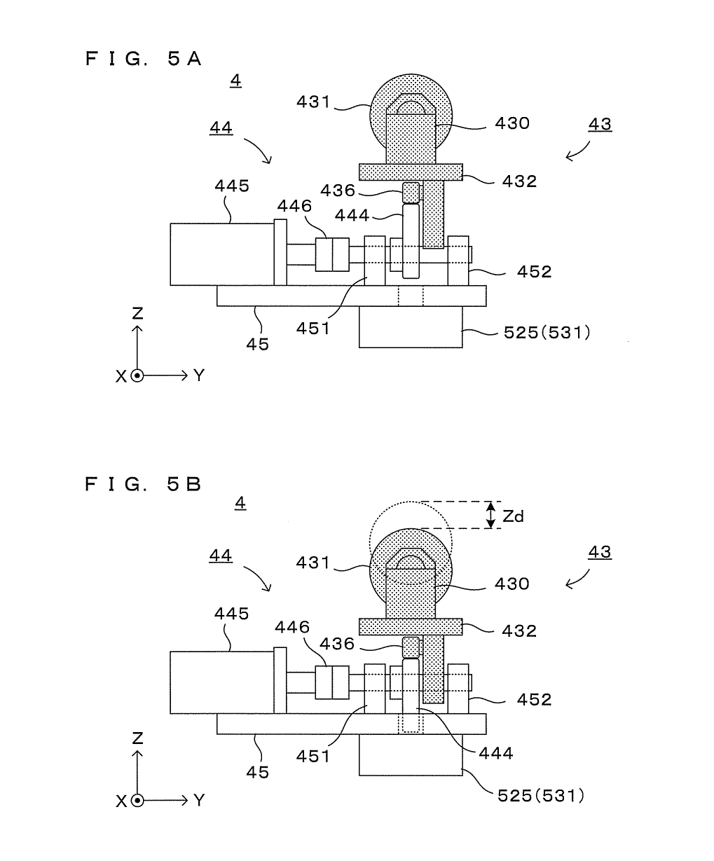

FIG. 3 is a perspective view showing the configuration of the transfer roller block. Further, FIGS. 4A and 4B are front views showing the configuration of the transfer roller block. Further, FIGS. 5A and 5B are side views showing the configuration of the transfer roller block. Note that, in each figure, some members are not shown to make the configuration and operation easily visible. The transfer roller block 4 is structured such that the lifter unit 44 is mounted on the plate member 45 supported in a horizontal posture and movably in the Y direction by the guide rails 51, 53 and the roller unit 43 is supported by the lifter unit 44. The plate member 45 is a substantially T-shaped flat plate member as shown in FIG. 3.

The roller unit 43 provided in the transfer roller block 4 includes a transfer roller 431 formed into a roller shape extending in the X direction as a longitudinal direction. The transfer roller 431 is such that a surface layer of an elastic material, e.g. a rubber material is provided on a surface of a hollow or solid cylindrical core. A length of the transfer roller 431 in the X direction is equal to or longer than that of the substrate SB in the X direction.

The transfer roller 431 is rotatably supported by a pair of supports 430, 430 provided on opposite end parts in the X direction of an elevating member 432 whose upper surface is a horizontal flat surface extending in the X direction as a longitudinal direction. The both supports 430 are symmetrically shaped with respect to an YZ plane and identical in structure. Each of the supports 430 includes a bearing 433, a biasing portion 434 and a stopper 435.

The bearing portion 433 includes a column member 4331 standing on the elevating member 432, a linear guide including a guide rail 4332 provided in the vertical direction on the column member 4331 and a slider 4333 engaged with the guide rail 433, a supporting angle 4334 fixed to the slider 4333 and an auto-centering bearing 4335 mounted on the supporting angle 4334. The auto-centering bearing 4335 rotatably supports a rotary shaft of the transfer roller 431. The supporting angle 4334 is attached to the slider 4333 of the linear guide. Thus, the supporting angle 4334 is vertically movable within a movable range of the linear guide.

The biasing portion 434 for mechanically biasing the supporting angle 4334 upwardly is provided between the supporting angle 4334 and the elevating member 432. For example, an air cylinder can be used as the biasing portion 434. The air cylinder is connected to a press controller 93 provided in the control unit 9 and applies a biasing force set by the press controller 93 to the supporting angle 4334. Upon receiving an upward biasing force, the supporting angle 4334 is displaced upwardly, but that displacement is restricted by the stopper 435.

Specifically, an adjustment screw as the stopper 435 is mounted in a screw hole provided in a plate 4336 attached to an upper part of the column member 4331. By the contact of the lower end of the stopper 435 with the upper surface of the supporting angle 4334, an upward displacement of the supporting angle 4334 is restricted. The stopper 435 restricts a displacement of the supporting angle 4334 against the biasing force from the biasing portion 434 within the movable range of the linear guide and within a range where the supporting angle 4334 is movable upward and downward by the biasing force by the biasing portion 434. Thus, the supporting angle 4334 remains at a fixed position in a state where an upward biasing force from the biasing portion 434 is applied thereto and any further upward displacement thereof is restrained by abutment against the stopper 435. The position (Z-direction position) of the supporting angle 4334 with respect to the elevating member 432 at this time is referred to as a “restrained position” below. The stopper 435 is the adjustment screw and the restrained position can be changed and adjusted by increasing and decreasing a screwed amount of the adjustment screw into the plate 4336. This adjustment can be independently performed between the supports 430, 430 provided on opposite end parts of the transfer roller 431.

Note that an elastic body such as a spring or elastic resin, a body utilizing a magnetic repulsive force or the like can be used as the biasing portion 434 beside the air cylinder described above. The use of the air cylinder is advantageous in that the biasing force can be freely changed. Further, a certain member may be interposed between the stopper 435 and the supporting angle 4334 instead of such a configuration that the lower end of the adjustment screw as the stopper 435 is directly in contact with the upper surface of the supporting angle 4334.

The supporting angle 4334 positioned at the restrained position at each of the opposite end parts of the elevating member 432 is provided with the auto-centering bearing 4335. The opposite end parts of the transfer roller 431 are rotatably supported by the auto-centering bearings 4335. The restrained positions of the two supporting angles 4334, 4334 are individually adjusted. Thus, not only a direction parallel to the X axis, but also a direction slightly oblique to the X axis in an XZ plane can be set as a direction of the rotary shaft of the transfer roller 431. The supporting angle 4334 is only vertically moved by the liner guide. However, by the auto-centering bearings 4335 supporting the transfer roller 431, the rotation of the transfer roller 431 is prevented from being obstructed even in a state where the rotary shaft is inclined.

The roller unit 43 configured as described above is supported movably upward and downward by the lifter unit 44 provided on the plate member 45. Specifically, the lifter unit 44 includes a pair of column members 441, 441 extending upward from the plate member 45 at positions different in the X direction. A linear guide movable in the vertical direction is attached to each column member 441. More specifically, a guide rail 442 of the linear guide is vertically attached to the column member 441 and a slider 443 engaged movably upward and downward with the guide rail 442 is fixed to the elevating member 432 of the roller unit 43. Thus, the elevating member 432 can move upward and downward in the vertical direction while the upper surface thereof is maintained in a horizontal posture.

Further, the lifter unit 44 includes a cam member 444 arranged between the two column members 441 and a motor 445 for rotating the cam member 444. A rotary shaft of the cam member 444 extends in a horizontal direction parallel to the Y direction and is rotatably supported by bearing members 451, 452 provided on the plate member 45. The rotary shaft of the cam member 444 is connected to the motor 445 via a coupling 446. The motor 445 is fixed to the plate member 45 and connected to a roller elevation controller 94 of the control unit 9.

An upper end part of the cam member 444 is in contact with a cam follower 436 rotatably mounted on the elevating member 432 above the rotary shaft of the cam member 444. Thus, a length from the rotary shaft of the cam member 444 to the upper end part specifies an interval between the elevating member 432 and the plate member 45. The motor 445 rotates the cam member 444, whereby the interval between the elevating member 432 and the plate member 45 changes. Specifically, the cam member 444 has a function of translating a rotational motion of the motor 445 into an upward and downward motion of the elevating member 432.

FIGS. 4A and 5A show a state where a part of the cam member 444 having a relatively large radius is located above by the rotation of the cam member 444 and the length from the rotary shaft to the upper end part is relatively long. At this time, the elevating member 432 is largely lifted up with respect to the plate member 45. On the other hand, FIGS. 4B and 5B show a state where a part of the cam member 444 having a relatively small radius is located above and the length from the rotary shaft to the upper end part is relatively short. At this time, the interval between the plate member 45 and the elevating member 432 becomes smaller. In FIGS. 5A and 5B, the roller unit 43 configured to move upward and downward by the rotation of the cam member 444 is shaded with dots to make the motion easily understandable.

As just described, a height of the elevating member 432 with respect to the plate member 45 changes depending on a rotational angle of the cam member 44, whereby a height of the transfer roller 431 can be changed. By supporting the elevating member 432 by a pair of linear guides (guide rails 442, the sliders 443) provided across the cam member 44, the transfer roller 431 can be parallelly moved in the vertical direction with an angle of the rotary shaft of the transfer roller 431 maintained.

As described later, the upper end of the transfer roller 431 is in contact with the lower surface of the blanket BL held on the lower stage 31, for example, in a state shown in FIG. 5A where the transfer roller 431 is lifted upwardly. In this state, the transfer roller 431 is pressed against the lower surface of the blanket BL by biasing forces applied to the supporting angles 4334 from the biasing portions 434. Thus, the transfer roller 431 pushes the blanket BL upwardly and presses the blanket BL against the substrate SB. Accordingly, the Z-direction position of the transfer roller 431 at this time is referred to as a “pressing position”.

With the transfer roller 431 positioned at the pressing position, the roller travel driver 5 causes the transfer roller block 4 to travel in the Y direction. By doing so, the transfer roller 431 moves while pressing the blanket BL against the substrate SB. In this way, a close-contact area where the blanket BL and the substrate SB are held in close contact spreads in the Y direction and, finally, the entire substrate SB is held in close contact with the blanket BL.

On the other hand, the transfer roller 431 is largely separated downwardly from the blanket BL, for example, in a state where the transfer roller 431 is located below as shown in FIG. 5B. Accordingly, the Z-direction position of the transfer roller 431 at this time is referred to as a “separated position”. A difference between the pressing position and the separated position, i.e. a height indicated by Zd in FIG. 5B is about several mm through 30 mm. This height difference is specified by a radius change amount associated with the rotation of the cam member 444.

As shown in FIGS. 3 and 4A, opposite end parts of the plate member 45 in the X direction extend further outward than the opposite end parts of the transfer roller 431. Further, as shown in FIG. 2, the opposite end parts of the plate member 45 in the X direction extend further outward than opposite end surfaces in the X direction of the opening 311 in the central part of the lower stage 31 and extend up to the vicinities of opposite outer peripheral end parts of the lower stage 31 in the X direction. The opposite end parts of the plate member 45 in the X direction are supported on the guide rails 51, 53 substantially below the opposite outer peripheral end parts of the lower stage 31 in the X direction. In this way, the plate member 45 is supported at opposite end positions widely distant in the X direction. Thus, also when the transfer roller 431 travels in the Y direction while pressing the blanket BL, it is possible to maintain the plate member 45 in a horizontal posture by suppressing the inclination of the plate member 45. In this way, the travel of the roller unit 4 is stabilized.

Next, a transfer process by the transfer apparatus 1 configured as described above is described. Here, a transfer process of transferring a pattern or thin film from the blanket BL to the substrate SB is described. As described above, by replacing the substrate SB by the plate PP, an operation in the patterning process is also described. The transfer process described below is realized by the control unit 9 causing each component of the apparatus to perform a predetermined operation by executing a control program prepared in advance.

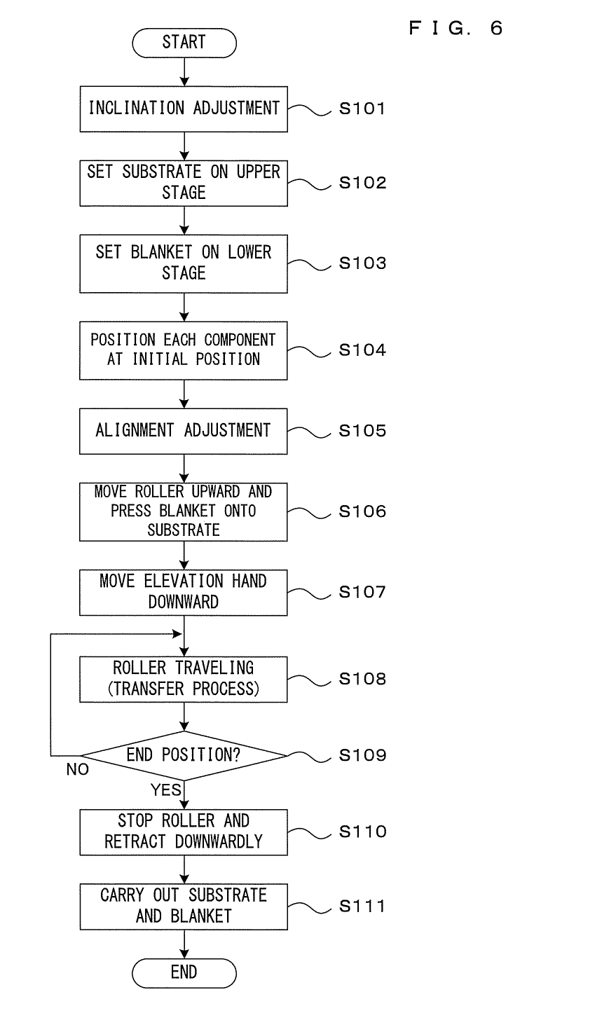

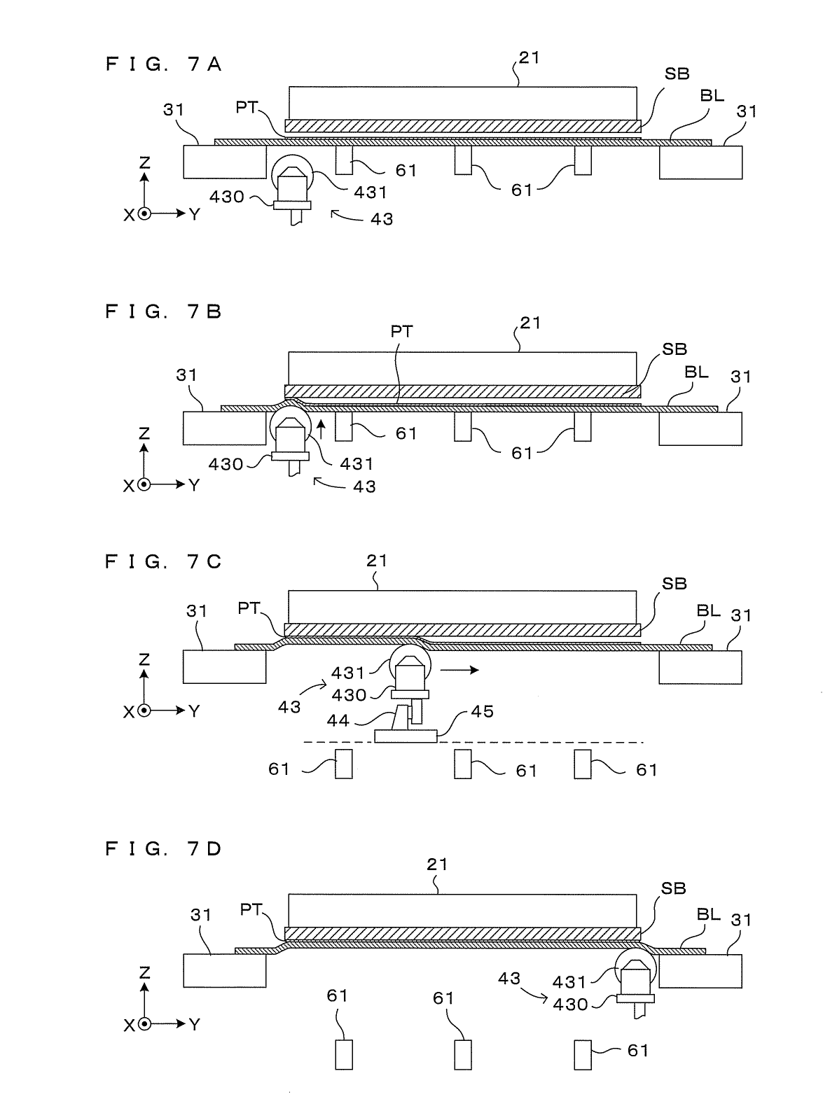

FIG. 6 is a flow chart showing the transfer process by this transfer apparatus. Further, FIGS. 7A to 7D are diagrams schematically showing the position of each component in the process of the transfer process. At first, an inclination adjustment process of the transfer roller 431 is performed (Step S101). The inclination adjustment process is described later. In the transfer process, a substrate SB to which a pattern or thin film is to be transferred is carried into the apparatus and set on the upper stage 21 (Step S102). The upper stage 21 sucks and holds the substrate SB such that a transfer surface to which the pattern or thin film is to be transferred is faced down. Subsequently, a blanket BL carrying the pattern or thin film to be transferred to the substrate SB is carried into the apparatus and set on the lower stage 31 (Step S103). The lower stage 31 sucks and holds the blanket BL such that a carrying surface carrying the pattern or thin film is faced up.

Subsequently, each component of the apparatus is positioned at a predetermined initial position (Step S104). FIG. 7A shows the initial position of each component. The upper stage 21 and the lower stage 31 are arranged to proximately face each other such that the substrate SB and the blanket BL face each other in parallel across a predetermined gap. Further, the elevation hands 61 are raised to a position where the upper surfaces thereof are flush with the upper surface of the lower stage 31 and come into contact with the lower surface of the blanket BL to support the blanket BL in a horizontal posture. The transfer roller 431 is positioned at the separated position to be separated downwardly from the lower surface of the blanket BL at a position right below one end part of the substrate SB in the Y direction. In FIG. 7A, PT denotes an object to be transferred (pattern or thin film) from the blanket BL to the substrate SB.

Subsequently, an alignment adjustment process of adjusting the positions of the substrate SB and the blanket BL in the horizontal direction is performed (Step S105). Specifically, based on images imaged by the cameras 72, the alignment mechanism 7 moves the alignment stage 36 in a horizontal plane if necessary such that the pattern or thin film PT carried on the blanket BL and the substrate SB have a positional relationship determined in advance in the horizontal direction.

After the alignment adjustment process, the motor 445 rotates the cam member 444, whereby the transfer roller 431 moves upward to come into contact with the lower surface of the blanket BL and press the blanket BL upwardly as shown in FIG. 7B (Step S106). The transfer roller 431 continues to move upward also after coming into contact with the lower surface of the blanket BL, whereby the blanket BL is pushed up by the transfer roller 431 and, finally, the upper surface of the blanket BL comes into contact with the lower surface of the substrate SB. In this way, the pattern or thin film PT carried on the upper surface of the blanket BL is held in close contact with the substrate SB.

The transfer roller 431 further pushes up the blanket BL, whereby the pattern or thin film PT is pressed against the substrate SB. In this way, the pattern or thin film PT is transferred to the substrate SB. Since the blanket BL is maintained in the horizontal posture by being supported by the elevation hands 61, a positional deviation in the horizontal direction when the blanket BL is pushed up is prevented and the pattern or thin film PT is properly transferred to a predetermined position of the substrate SB.

After the substrate SB and the blanket BL come into contact by being pressed by the transfer roller 431, the elevation hands 61 move downward (Step S107) and are separated from the blanket BL as shown in FIG. 7C. Then, the roller unit 43 starts traveling in the (+Y) direction (Step S108). At this time, the elevation hands 61 are positioned such that the upper surfaces thereof are located below the lower surface position of the plate member 45 shown by a broken line in FIG. 7C.

Except for projections by the slider 531 and the nut portion 525 provided outside the opening 311 of the lower stage 31, the lower surface of the plate member 45 is lowest out of constituent components of the transfer roller block 4. Thus, by lowering the elevation hands 61 to positions below the lower surface position of the plate member 45, the interference of the transfer roller block 4 traveling in the Y direction and the elevation hands 61 is avoided.

In this embodiment, the roller unit 43 is moved upward and downward by the rotation of the cam member 444 provided in the lifter unit 44 and the rotary shafts of the motor 445 and the cam member 444 extend in the horizontal direction. Thus, a height of the transfer roller block 4 in the vertical direction is suppressed and an upward/downward moving distance of the elevation hands 61 can also be suppressed to be small. Further, the transfer roller block 4 is supported on the opposite end parts of the plate member 45 in the X direction and there is no leg portion extending downward from the transfer roller 431 inside the opening 311 of the lower stage 31. Thus, each elevation hand 61 can be formed by a single member continuous in the X direction.

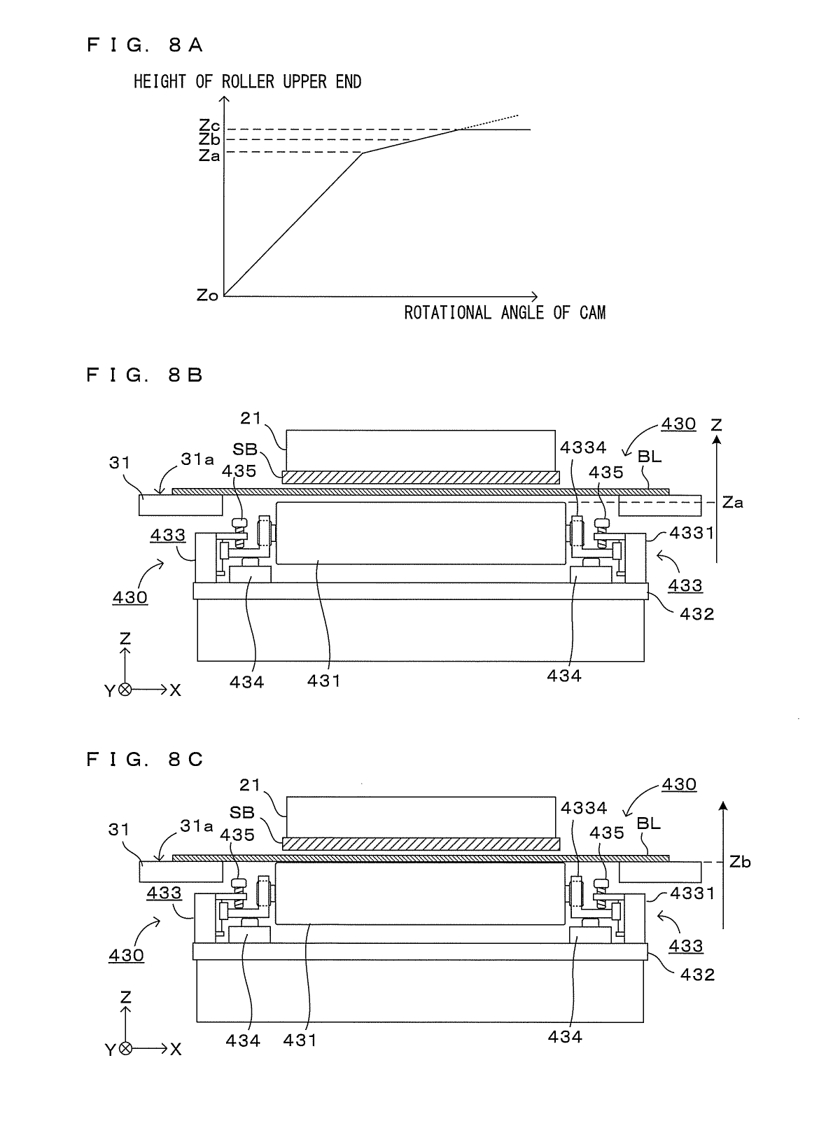

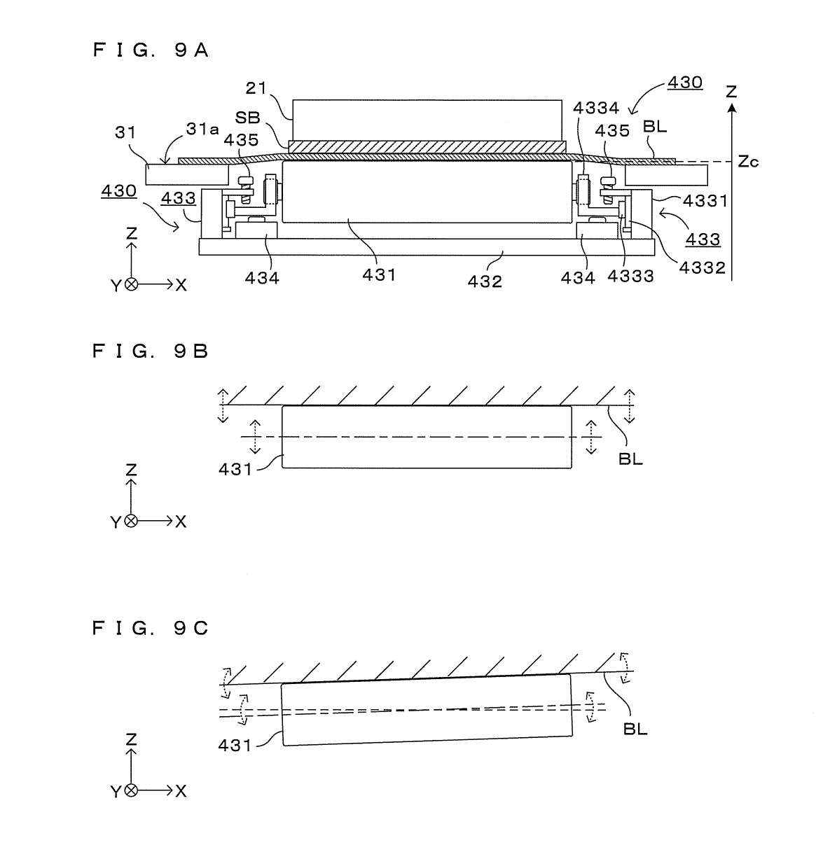

The operation of each component until the transfer roller 431 is moved upward by the rotation of the cam member 444 and comes into contact with the blanket BL to press the blanket BL against the substrate SB is described in more detail with reference to FIGS. 8A to 8C and 9A to 9C. FIGS. 8A to 8C are diagrams showing the operation until the transfer roller comes into contact with the blanket. Further, FIGS. 9A to 9C are diagrams showing a state where the transfer roller presses the blanket against the substrate.

The transfer roller 431 is moved upward by the rotation of the cam member 444 and, associated with this, a height of the upper end part of the transfer roller 431 changes. As shown in FIG. 8A, the height of the transfer roller 431 initially quickly increases in relation to an increase of a rotational angle of the cam member 44 from the initial position. At a certain height Za, an increase of the height with respect to the rotational angle becomes moderate. In other words, the shape of the cam member 444 is set such that a rising speed of the upper end of the transfer roller 431 (hereinafter, referred to as a “roller upper end”) when the cam member 444 is rotated at a constant speed has such a profile. A height Zo is a height of the roller upper end when the transfer roller 431 is at the separated position.

As shown in FIG. 8B, the height Za is a height of the roller upper end immediately before the roller upper end comes into contact with the blanket BL. In principle, the height Za may be a height slightly lower than the height of the upper surface 31a of the lower stage 31 on which the blanket BL is placed, but a margin may be further given in consideration of the deflection of the blanket BL. By setting a relatively high rising speed of the transfer roller 431 until the roller upper end comes into contact with the blanket BL, a time until the transfer roller 431 comes into contact with the blanket BL can be shortened.

When the transfer roller 431 comes into contact with the blanket BL, an impact is applied to the blanket BL and the blanket BL or the pattern carried thereon may be damaged if the rising speed is excessively high. To avoid this, the transfer roller 431 moves upward at a lower rising speed and comes into contact with the blanket BL after the roller upper end reaches the height Za. Note that the roller upper end needs not necessarily linearly change with respect to the cam rotational angle as in this example. The rising speed of the transfer roller 431 may be set high in an initial stage and slowed immediately before the transfer roller 431 comes into contact with the blanket BL.

Before the transfer roller 431 comes into contact with the blanket BL, the supporting angles 4334 of the roller unit 43 are pressed against the stoppers 435 by biasing forces of the biasing portions 434. The stoppers 435 resist against the biasing forces to restrain upward displacements of the supporting angles 4334 to the restrained position and the transfer roller 431 also remains at a fixed position.

A height Zb of the roller upper end when the transfer roller 431 comes into contact with the blanket BL is substantially equal to the height of the upper surface 31a of the lower stage 31 on which the blanket BL is placed as shown in FIG. 8C. When the cam member 444 further rotates, the roller upper end moves further upward beyond the height Zb. In this way, the blanket BL is pushed up. Finally, the blanket BL is pressed against the substrate SB held by the upper stage 21 and the upward movement of the transfer roller 431 is stopped.

As shown by a dotted line in FIG. 8A, the cam member 44 moves the roller unit 43 further upward beyond a height Zc of the roller upper end when the blanket BL comes into contact with the substrate SB. However, the transfer roller 431 abuts against the upper stage 21 via the blanket BL and the substrate SB and the upward movement thereof is stopped. Thus, as shown in FIG. 9A, the transfer roller 431 is pushed relatively downwardly with respect to the elevating member 432 to separate the supporting angles 4334 and the stoppers 435.

As a result, the transfer roller 431 is released from restraint by the stoppers 435, becomes vertically movable and is pressed against the blanket BL by upward biasing forces by the biasing portions 434. Accordingly, the magnitude of a pressing force of the transfer roller 431 to the blanket BL is determined by the biasing forces by the biasing portions 434. If the biasing portions 434 are air cylinders, the biasing forces can be adjusted by a control from the press controller 93. Thus, the pressing force to the blanket BL can be appropriately set by the press controller 93. Also, if the pressing force needs to be changed according to a material, such a change can be easily dealt with without changing the apparatus configuration. If the biasing portions 434 use springs, the pressing force can be similarly adjusted by using springs having an appropriate spring constant. If the biasing portions 434 uses magnetic forces, the pressing force can be similarly adjusted by using magnets (permanent magnets or electromagnets) having an appropriate magnetic flux density.

As just described, in this embodiment, the pressing force of the transfer roller 431 to the blanket BL can be uniquely determined by the configuration of the biasing portions 434. Thus, the lifter unit 44 for raising and lowering the roller unit 43 has only to have a function of maintaining the roller unit 43 at a predetermined height against the biasing forces by the biasing portions 434 and a reaction force from the blanket BL and does not require fine adjustments of the height and the pressing force. The lifter unit 44 using the cam member 444 for raising and lowering the roller is suitable for this purpose.

Further, if the flatness of the surface of any one of the upper stage 21, the substrate SB and the blanket BL is deteriorated due to processing accuracy, deterioration with age or the like, the height of the lower surface of the blanket BL in contact with the transfer roller 431 may vary as shown in FIG. 9B or the inclination of the lower surface of the blanket BL may change as shown in FIG. 9C as the transfer roller 431 travels in the Y direction. Also in these cases, since the opposite ends of the transfer roller 431 are respectively independently biased, the pressing force to the blanket BL can be maintained to be constant by the transfer roller 431 moving, following a variation of the lower surface of the blanket BL. Thus, the pattern can be satisfactorily and stably transferred from the blanket BL to the substrate SB.

A condition necessary to cause the transfer roller 431 to follow the variation of the lower surface of the blanket BL is that strokes (vertical movable ranges) of the supporting angles 4334 are larger than an assumed variation of flatness in a state where the transfer roller 431 is pressed against the blanket BL by the biasing forces of the biasing portions 434 as shown in FIG. 9A. For example, in the transfer apparatus 1 for manufacturing an electronic device, this variation of flatness is assumed to be about several tens of microns. Thus, the stroke of the supporting angle 4334 has only to be several mm.

A stroke of the linear guide (guide rail 4332 and slider 4333) for supporting the supporting angle 4334 movably upward and downward has only to be about the same and a relatively small product can be used. In the roller unit 43, a load to the biasing portion 434 is due to the masses of the transfer roller 431, the supporting angle 4334 and the slider 4333 and a response time of the transfer roller 431 to follow the variation of the lower surface of the blanket BL can be shortened by reducing these in weight and suppressing the load of the biasing portion 434 to be small.

A mechanism (lifter unit 44) for moving the transfer roller 431 from the separated position to the pressing position and a mechanism (supports 430) for causing the transfer roller 431 to follow the variation of the lower surface position of the blanket BL are independent mechanisms. Thus, the supports have only to have a stroke capable of accommodating the variation of the lower surface position of the blanket BL and a load associated with the transfer roller 431 can be reduced in this way.

Note that, concerning the variation of flatness described above, a part of the lower surface of the blanket BL with which the transfer roller 431 first comes into contact may be inclined from a horizontal plane. Also in such a case, the transfer roller 431 needs to evenly and uniformly come into contact with the blanket BL in the X direction. To this end, the upper end of the transfer roller 431 when the transfer roller 431 comes into contact with the blanket BL needs to be inclined in accordance with the inclination of the blanket BL.

In this embodiment, the transfer roller 431 separated from the blanket BL is supported by the supporting angles 4334 restrained at the restrained position by the stoppers 435, and the restrained position can be adjusted by the adjustment screws. If the restrained position is adjusted in advance at the opposite end parts of the transfer roller 431 to make the roller upper end and the lower surface of the blanket BL parallel to each other immediately before the transfer roller 431 comes into contact with the blanket BL, the transfer roller 431 can be evenly and uniformly brought into contact with the blanket BL in the X direction. Such an adjustment process is performed in advance as the “inclination adjustment” process in Step 101 of FIG. 6. In this way, the direction of the rotary shaft of the transfer roller 431 is adjusted within a predetermined angle range in an XZ plane centered on a direction parallel to the X direction.

When the transfer roller 431 first comes into contact with the blanket BL, the blanket BL is not affected by the flatness of the substrate SB and the upper stage 21. Thus, the lower surface of the blanket BL can be considered to be flush with the upper surface 31a of the lower stage 31. From this, the restrained position may be set to make the upper surface 31a of the lower stage 31 and the roller upper end parallel. By doing so, it is not necessary to make the inclination adjustment every time the transfer process is performed.

Further, for example, an adjustment method may be adopted which indirectly ensures parallelism between the upper surface 31a of the lower stage 31 and the roller upper end by adjusting the upper surface 31a of the lower stage 31 and the roller upper end to be horizontal using an appropriate measuring instrument such as a laser displacement meter.

Referring back to FIG. 6, the transfer process is further described. In Step S108, the transfer roller 431 moves in the Y direction while pressing the blanket BL against the substrate SB. This causes the area where the blanket BL and the substrate SB are held in close contact via the pattern or thin film PT to spread in the Y direction as shown in FIG. 7C. In this way, the pattern or thin film PT is successively transferred to the substrate SB (transfer process). The transfer roller 431 moves upward to the pressing position where the blanket BL can be pressed with a constant pressing force and moves in the Y direction in this state.

The travel of the roller unit 43 is continued until the transfer roller 431 reaches an end position immediately below a (+Y) side end part of the substrate SB as shown in FIG. 7D (Step S109). This causes the entire substrate SB to be held in contact with the blanket BL and the transfer of the pattern or thin film PT to the substrate SB is completed. At this point of time, the movement of the roller unit 43 is stopped and the roller unit 43 is separated from the blanket BL and retracted downwardly (Step S110). The blanket BL and the substrate SB held in close contact in this way are integrally carried out (Step S111) and the transfer process in this transfer apparatus 1 is finished.

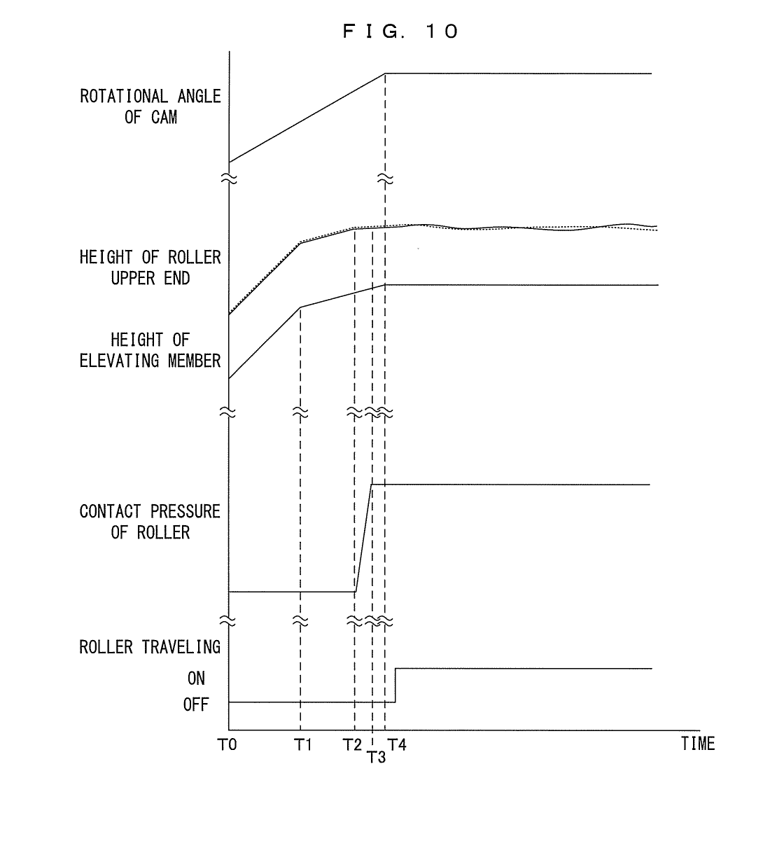

FIG. 10 is a timing chart showing the operation of each component. The operation of each component in the above transfer process is organized with reference to FIG. 10. When the cam member 444 starts rotating from the initial position at time TO, the roller unit 43 moves upward and, associated with this, the transfer roller 431 also moves upward. By performing the inclination adjustment described above, the upper end of the transfer roller 431 is not necessarily horizontal. Specifically, the height of the roller upper end is not necessarily equal on the opposite end parts of the transfer roller 431. In FIG. 10, examples of changes of the upper end height of the respective opposite end parts of the transfer roller 431 in the X direction are individually shown by a solid line and a broken line to illustrate a more generalized state.

The rising speed of the roller unit 43 is reduced at time T1, and the roller upper end comes into contact with the lower surface of the blanket BL at time T2. The cam member 444 rotates further and the roller unit 43 moves upward, whereby the transfer roller 431 pushes up the blanket BL and a pressing force applied to the blanket BL increases. At time T3, the blanket BL is pressed against the substrate SB. By the further rotation of the cam member 444, the restraint on the supporting angles 4334 by the stoppers 435 is released. Thereafter, the roller upper ends on the opposite end parts of the transfer roller 431 individually change, following the variation of the lower surface of the blanket BL and the pressing force to the blanket BL is maintained to be constant by biasing forces of the biasing portions 434.

At time T4 at which the roller unit 43 moves upward to the position where the strokes of the supporting angles 4334 are sufficiently ensured, the rotation of the cam member 444 is stopped and the upward movement of the roller unit 43 also stops. In this state, the roller travel driver 5 causes the transfer roller block 4 to travel, whereby the transfer can proceed while the constant pressing force is stably applied to the blanket BL and the substrate SB over the entire roller travel period.

In the transfer process described above, the transfer roller 431 can press the blanket BL with the constant pressing force until the transfer is finished and the transfer roller 431 is separated from the blanket BL after the transfer roller 431 causes the blanket BL to come into contact with the substrate SB. Thus, the pattern PT carried on the blanket BL can be satisfactorily transferred to the substrate SB. Further characteristics and their functions of each component contributing to such an effect in this embodiment are described below.

In this embodiment, the transfer roller block 4 and the lower stage 31 are both placed on the alignment stage 36. According to such a configuration, the transfer roller block 4 and the lower stage 31 integrally move when the alignment stage 36 moves by the operation of the alignment mechanisms 71. Thus, the transfer roller 431 and the lower stage 31 when the transfer roller 431 first comes into contact with the blanket BL are kept in a positional relationship determined in advance in the horizontal direction. This can suppress a positional deviation of the blanket BL relative to the substrate SB, which could occur when the transfer roller 431 starts contacting the blanket BL, as described below.

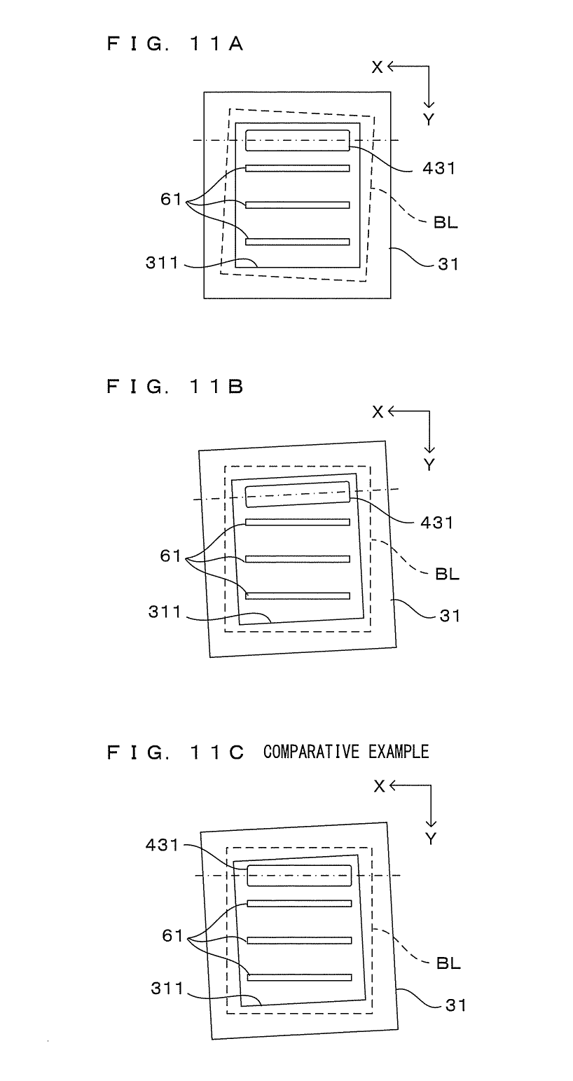

FIGS. 11A to 11C are diagrams showing positional relationships of each component before and after the alignment adjustment. Here, a change in the positional relationship of the respective apparatus components, specifically, the lower stage 31, the transfer roller 431 and the elevation hands 61 before and after the alignment adjustment is considered. In an initial stage before the blanket BL is placed on the lower stage 31, sides of a rectangle corresponding to the outer periphery of the lower stage 31 are oriented along XY coordinate axes as shown in FIG. 11A. Thus, an axial direction of the transfer roller 431 shown by a dashed-dotted line and longitudinal directions of the elevation hands 61 are all X direction.

The blanket BL is placed on the lower stage 31 thus initialized. At this time, the blanket BL may be set while being inclined with respect to the lower stage 31 or displaced in any direction in an XY plane as shown by a broken line in FIG. 11A. The alignment adjustment process is performed to eliminate a positional deviation between the substrate SB and the blanket BL (more precisely, between the substrate SB and an object to be transferred on the blanket BL) due to such a deviation of the set position of the blanket BL.

After the alignment adjustment, the positional deviation of the blanket BL with respect to the XY coordinate axes is eliminated as shown in FIG. 11B. However, as a result, the lower stage 31 is displaced from the initial position. In this embodiment, the transfer roller block 4 is mounted on the alignment stage 36. Thus, when the alignment stage 36 moves by the operation of the alignment mechanisms 71, the transfer roller block 4 integrally moves with the alignment stage 36 together with the lower stage 31. Therefore, even if the alignment mechanisms 71 operate, the relative position of the transfer roller 431 with respect to the lower stage 31 does not change.

In contrast, as shown as a comparative example in FIG. 11C, the positional relationship of the lower stage 31 and the transfer roller 431 changes before and after the alignment adjustment in a configuration in which only the lower stage 31 is displaced when the alignment stage 36 is moved by the alignment mechanisms 71. Thus, the position where the transfer roller 431 moving upward first comes into contact with the lower surface of the blanket BL varies within the opening 311 of the lower stage 31.

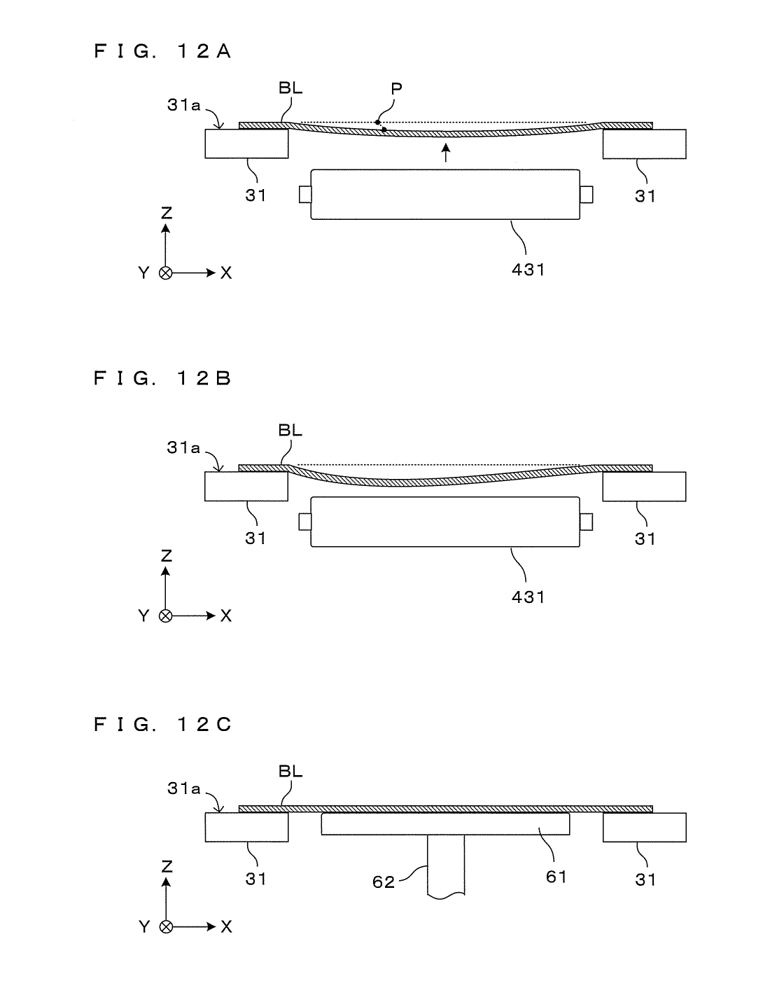

FIGS. 12A to 12C are diagrams illustrating states of deflection of the blanket on the lower stage. The blanket BL is unavoidably deflected into the opening 311 of the lower stage 31 due to its own dead weight. The amount of deflection increases as the blanket BL is located at a more distant position from the lower stage 31 supporting the blanket BL from below. At this time, as shown in FIG. 12A, the blanket BL is deformed to be pulled into the opening 311. Thus, a point P on the blanket BL is displaced to a center side of the opening 311 in the horizontal direction.

The transfer roller 431 lifts up the blanket BL deflected downward in this way to a position right above. Thus, the blanket BL is pressed against the substrate SB without correcting a positional deviation in the horizontal direction caused due to deflection. Specifically, a point on the substrate SB where the point P comes into contact is different from a proper position and this causes a transfer positional deviation of the pattern. Such a positional deviation is likely to become large particularly near the end position in the opening 311 where the transfer roller 431 first comes into contact.

Further, once the substrate SB and the blanket BL come into contact, a new positional deviation between the both is unlikely to occur thereafter. In other words, overlap accuracy between the substrate SB and the blanket BL is substantially determined by the amount of positional deviation when the both first come into contact. Thus, it is important to suppress the amount of deflection in a part of the blanket BL held by the lower stage 31 to be first brought into contact with the transfer roller 431.

Further, if an interval between the transfer roller 431 and the lower stage 31 differs between the opposite end parts of the transfer roller 431 as shown in FIG. 11C, the amount of deflection of the blanket BL is asymmetric on the opposite end parts in the X direction. In addition, the amount of deflection changes every time depending on the relative positions of the substrate SB and the blanket BL in the initial state (before the alignment adjustment), i.e. at which positions the substrate SB and the blanket BL are set. Thus, the amount of positional deviation of the blanket BL with respect to the substrate SB varies in each process and it is difficult to improve overlap accuracy.

In this embodiment, the relative positional relationship of the lower stage 31 and the transfer roller 431 does not change before and after the alignment adjustment. Thus, the amount of deflection of the blanket BL at the position right above the transfer roller 431 in the initial state is constant. From this, it is also possible to perform the alignment adjustment taking into account a positional deviation due to deflection if necessary. This enables overlap accuracy to be improved.

Further, as shown in FIG. 12C, the central part of the lower surface of the blanket BL facing the opening 311 of the lower stage 31 is supported from below by the elevation hands 61 extending in the X direction in this embodiment. In this way, the amount of deflection of the blanket BL itself is reduced. This point also contributes to an improvement of positional accuracy. Note that the supporting hand unit 6 including the elevation hands 61 is mounted on the main frame 10. Thus, the elevation hands 61 do not follow the lower stage 31 during the alignment adjustment. However, the elevation hands 61 are merely for suppressing deflection by auxiliary supporting the blanket BL and do not affect positional accuracy. Of course, the supporting hand unit 6 may be configured to integrally move with the lower stage 31 during the alignment.

Here, in the configuration described in the above literature, elevation hands are divided into two in the X direction to avoid interference when a transfer roller block travels and a central part of a blanket is not supported. Thus, the central part may be deflected particularly if the blanket has a characteristic of being easy to deflect. In contrast, in this embodiment, a wide range of the blanket BL including a center position in the X direction is supported by the single elevation hand 61. Thus, the deflection of the central part of the blanket BL, which is an effective area carrying an effective pattern or the like, can be effectively suppressed.

The elevation hand 61 can be a single member continuous in the X direction because the height of the transfer roller block 4 is suppressed and the transfer roller block 4 is supported on the opposite end parts outside the opening 311 of the lower stage 31 in the X direction. By doing so, leg portions extending downward from the transfer roller 431 are not necessary and it is not necessary to provide a space for allowing the passage of the leg portions during the travel of the transfer roller block 4. As a result, the elevation hand can be a single member capable of effectively supporting a wide area of the blanket central part without being divided in the X direction.

In this embodiment, the mechanism for raising and lowering the transfer roller 431 is configured using the cam member 444. Specifically, a rotational motion of the motor 445 about the horizontal rotary shaft is translated into a vertical linear reciprocal motion by the cam member 444 having the horizontal rotary shaft, whereby the roller unit 43 is raised and lowered. Thus, for example, as compared to an elevating mechanism using a ball screw mechanism having a vertical drive shaft, the height of the entire transfer roller block 4 can be suppressed. Since the roller unit 43 is supported movably upward and downward by the pair of linear guides provided across the cam member 444, the roller unit 43 can vertically move while maintaining the posture of the transfer roller 431.

Further, in the roller unit 43 of this embodiment, the transfer roller 431 is supported by the pair of supports 430 provided to correspond to the opposite end parts of the transfer roller 431. Each of the supports 430 has a function of biasing the rotary shaft of the transfer roller 431 upward, i.e. in a direction to press the blanket BL against the substrate SB while rotatably supporting the transfer roller 431. Thus, the magnitude of the pressing force to the blanket BL can be controlled by the biasing forces and the blanket BL can be pressed with a proper pressing force corresponding to the material and the purpose.

The heights of the opposite axial end parts of the transfer roller 431 are regulated by the stoppers 435 for restraining the supporting angles 4334 at the restrained position against the biasing forces of the biasing portions 434. Thus, the posture of the transfer roller 431 immediately before contact with the blanket BL is controlled and the transfer roller 431 can be brought into contact with the blanket BL uniformly and evenly in the X direction. This can prevent a positional deviation due to nonuniform pressing in overlapping the blanket BL and the substrate SB.

Further, the transfer roller block 4 is supported by the roller travel driver 5 on the opposite end parts of the plate member 45 in the X direction. Thus, the inclination of the transfer roller block 4 about the Y axis during travel is suppressed and the posture of the transfer roller 431 can be more reliably controlled. This can make the pressing force applied from the transfer roller 431 to the blanket BL stable.

In this embodiment, the configuration for holding and pressing the blanket BL, i.e. the lower stage 31, the transfer roller block 4 and the roller travel driver 5 are all mounted on the detachable stage 37. In addition, the detachable stage 37 is attachable to and detachable from the alignment stage 36. Thus, when the sizes or specifications of the substrate SB and the blanket BL are changed, each of the above components can be integrally exchanged together with the detachable stage 37 and the maintenance of each component is easy. For example, the detachable stage 37 can be incorporated into the alignment stage 36 after the assembling of each block and the adjustments such as alignments are performed on the detachable stage 37. Further, deflection caused by the placement of heavy objects such as the transfer roller block 4 can be suppressed by integrating the alignment stage 36 and the detachable stage 37 to enhance rigidity and increase a withstand load.

As described above, in the transfer apparatus 1 of the above embodiment, the substrate SB and the blanket BL respectively correspond to a “first plate body” and a “second plate body” of the invention. The upper stage 21 and the lower stage 31 respectively function as a “first holder” and a “second holder” of the invention. Further, the roller travel driver 5 functions as a “traveling mechanism” of the invention, and the transfer roller block 4 and the roller travel driver 5 integrally function as a “presser” of the invention.

Further, in the transfer roller block 4, the transfer roller 431, the elevating member 432, the bearing portions 433, the biasing portions 434, the stoppers 435 and the auto-centering bearings 4335 respectively function as a “roller member”, an “elevating member”, a “bearing mechanism”, a “biasing mechanism”, “a restraining member” and an “auto-centering bearing” of the invention. Further, the plate member 45 functions as a “traveling member” of the invention and the lifter unit 44 functions as an “elevating mechanism” of the invention. In the lifter unit 44, the cam member 444 and the motor 445 respectively function as a “cam” and a “motor” of the invention. Furthermore, the control unit 9 including the press controller 93 functions as a “controller” of the invention.

Note that the invention is not limited to the above embodiment and various changes other than those described above can be made without departing from the gist of the invention. For example, the stopper 435 of the above embodiment is an adjustment screw mounted through the plate 4336 of the bearing portion 433. However, without limitation to such a structure, the stopper may restrict the position by causing, for example, a pin-shaped or block-shaped member to abut against the supporting angle 4334. Further, for the purpose of adjusting the inclination of the transfer roller 431, only either one of the pair of supports 430 may be provided with a restrained position adjusting function.

Further, in the above embodiment, the plurality of elevation hands 61 are supported by the supporting frame 62 and integrally move upward and downward. However, each elevation hand may be configured to individually move upward and downward, for example, as described in the above literature. If the elevation hands are, for example, successively lowered according to the travel of the transfer roller in such a configuration, the posture of the blanket can be more reliably controlled. Thus, this is effective, for example, in enlarging substrates. Further, the blanket may be supported by members of another shape having a flat upper surface instead of bar-like elevation hands 61.

Further, the above embodiment is directed to the transfer apparatus for transferring an object to be transferred such as a pattern carried on the blanket BL to the substrate SB. However, a technical concept of the invention is not limited to such transfer apparatuses for transferring a pattern or the like and is also applicable, for example, to a technique for bonding two plate bodies without via a pattern or the like.

As the specific embodiment is illustrated and described above, in a transfer apparatus according to the embodiment, the restraining member may be configured to be separated from the bearing mechanism when the roller member is at the pressing position. According to such a configuration, a pressing force of the roller member for pressing the second plate body is specified by a biasing force from the biasing mechanism. Thus, a necessary pressing force can be stably applied to the second plate body by appropriately setting the biasing force.

Further, for example, an upper end of the roller member may be parallel to a lower surface of the second plate body in a state where the roller member is separated from the second plate body and the restraining member restricts the bearing mechanism to the restrained position. According to such a configuration, the pressing force when the roller member first presses the second plate body becomes uniform in an axial direction of the roller member and a positional deviation and damage on the second plate body and the like due to nonuniform pressing can be suppressed.

Further, for example, the restrained position may be individually adjustable between the pair of the supports. According to such a configuration, the inclination of a rotary shaft of the roller member can be changed. Thus, even if the lower surface of the second plate body is, for example, inclined, the upper end of the roller member and the lower surface of the second plate body can be made parallel by adjusting the inclination of the roller member in accordance with the inclination of the lower surface.

Further, for example, the biasing mechanism may be configured to bias the bearing mechanism with a constant biasing force. According to such a configuration, a constant pressing force can be applied to the second plate body at each position in the axial and traveling directions of the roller member.

In this case, a mechanism including an air cylinder as a generation source of the biasing force can be used, for example, as the biasing mechanism. According to such a configuration, the roller member can be biased with the constant biasing force even if the roller member vertically moves, following the second plate body. This can stabilize the pressing force to the second plate body. In this case, a controller may be further provided which controls the air cylinder to adjust the biasing force. According to such a configuration, the biasing force can be increased and decreased by a control from the controller, wherefore the pressing force to the second plate body can be changed without changing the apparatus configuration.

Further, for example, the bearing mechanism may be configured to support the rotary shaft of the roller member by the auto-centering bearing. According to such a configuration, the roller member can be smoothly rotated also when the roller member moves, following the second plate body.

Further, for example, the presser may include a traveling member configured to be caused to travel in the traveling direction by the traveling mechanism, and the elevating member and the elevating mechanism may be mounted on the traveling member. According to such a configuration, the traveling mechanism has only to have a function of causing the traveling member to travel and the elevating mechanism has only to have a function of raising and lowering the elevating member with respect to the traveling member. Thus, the configurations of the respective traveling mechanism and elevating mechanism can be simplified and miniaturized. Further, the traveling member has only to hold the elevating mechanism and travel and has a high degree of freedom in shape. Thus, the entire presser can be reduced in weight and size.

In this case, for example, the elevating member may be configured to be supported movably upward and downward with respect to the traveling member by a plurality of linear guides having different positions in the axial direction. According to such a configuration, the inclination of the elevating member about an axis parallel to the traveling direction can be suppressed and the roller member can be raised and lowered with respect to the second plate body while the posture thereof is maintained.

Further, for example, the elevating mechanism may include a motor having a horizontal rotary shaft and a cam configured to translate a rotational motion of the motor into an upward and downward motion of the elevating member by being driven and rotated by the motor. According to such a configuration, since the elevating member can be raised and lowered without using a drive shaft extending in the vertical direction, it is possible to miniaturize the elevating mechanism, particularly suppress a height thereof.

Further, in a transfer method according to the invention, the position of the roller member restricted by the restraining member may be adjusted, for example, before the roller member comes into contact with the second plate body. According to such a configuration, the posture of the roller member immediately before contact with the second plate body can be adjusted. Thus, even if the lower surface of the second plate body is, for example, inclined, the inclination of the roller member can be adjusted in accordance with the inclination of the lower surface and the upper end of the roller member and the lower surface of the second plate body can be brought into contact while being held in parallel.

This invention is suitably applicable to a process for transferring an object to be transferred such as a pattern or thin film to various plate bodies such as glass substrates and semiconductor substrates. Further, the technical concept of the invention is applicable also in the case of directly bringing two plate-like bodies into contact without via a pattern or the like.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A transfer apparatus, comprising:
a first holder which holds a first plate body in a horizontal posture with a lower surface open;
a second holder which holds a second plate body with an upper surface of the second plate body proximately facing the lower surface of the first plate body and with a lower surface of a central part of the second plate body open, the central part of the second plate body facing the first plate body at the upper surface side, by holding a peripheral edge part of the second plate body; and
a presser which presses the second plate body against the first plate body by pushing up the central part of the second plate body, wherein
the presser includes: a roller member extending in an axial direction along the lower surface of the second plate body;
an elevating member provided with a pair of supports for supporting opposite end parts of the roller member in the axial direction;
an elevating mechanism which raises and lowers the elevating member, thereby moves the roller member between a pressing position where an upper end of the roller member comes into contact with the second plate body to press the second plate body against the first plate body and a separated position where the roller member is separated from the second plate body; and
a traveling mechanism which moves the elevating member in a traveling direction parallel to the lower surface of the second plate body and orthogonal to a rotary shaft of the roller member, and
each of the supports includes:
a bearing mechanism which rotatably supports one end part of the roller member;
a biasing mechanism which biases the bearing mechanism toward the second plate body; and
a restraining member which restricts a displacement of the bearing mechanism by a biasing force to a predetermined restrained position.

2. The transfer apparatus according to claim 1, wherein the restraining member is separated from the bearing mechanism when the roller member is at the pressing position.

3. The transfer apparatus according to claim 1, wherein in a state where the roller member is separated from the second plate body and the restraining member restricts the bearing mechanism to the restrained position, an upper end of the roller member is parallel to the lower surface of the second plate body.

4. The transfer apparatus according to claim 2, wherein in a state where the roller member is separated from the second plate body and the restraining member restricts the bearing mechanism to the restrained position, an upper end of the roller member is parallel to the lower surface of the second plate body.

5. The transfer apparatus according to claim 1, wherein the restrained positions are individually adjustable between the pair of the supports.

6. The transfer apparatus according to claim 2, wherein the restrained positions are individually adjustable between the pair of the supports.

7. The transfer apparatus according to claim 1, wherein the biasing mechanism biases the bearing mechanism with a constant biasing force.

8. The transfer apparatus according to claim 7, wherein the biasing mechanism includes an air cylinder as a generation source of the biasing force.

9. The transfer apparatus according to claim 8, further comprising a controller which controls the air cylinder to adjust the biasing force.

10. The transfer apparatus according to claim 2, wherein the biasing mechanism biases the bearing mechanism with a constant biasing force.

11. The transfer apparatus according to claim 10, wherein the biasing mechanism includes an air cylinder as a generation source of the biasing force.

12. The transfer apparatus according to claim 11, further comprising a controller which controls the air cylinder to adjust the biasing force.

13. The transfer apparatus according to claim 1, wherein the bearing mechanism supports the rotary shaft of the roller member by an auto-centering bearing.

14. The transfer apparatus according to claim 2, wherein the bearing mechanism supports the rotary shaft of the roller member by an auto-centering bearing.

15. The transfer apparatus according to claim 1, wherein the presser includes a traveling member which is caused to travel in the traveling direction by the traveling mechanism, and the elevating member and the elevating mechanism are mounted on the traveling member.

16. The transfer apparatus according to claim 15, wherein the traveling member includes a plurality of linear guides which have different positions in the axial direction and support the elevating member.

17. The transfer apparatus according to claim 15, wherein the elevating mechanism includes a motor having a horizontal rotary shaft and a cam which translates a rotational motion of the motor into an upward and downward motion of the elevating member.

18. The transfer apparatus according to claim 16, wherein the elevating mechanism includes a motor having a horizontal rotary shaft and a cam which translates a rotational motion of the motor into an upward and downward motion of the elevating member.

19. A transfer method for bringing a first plate body and a second plate body into close contact and transferring an object to be transferred carried on the one plate body to the other plate body, the transfer method comprising:
arranging the first plate body and the second plate body in a horizontal posture by causing the first plate body and the second plate body to proximately face each other across the object to be transferred;
bringing a roller member having opposite end parts respectively rotatably supported by a pair of supports and biased toward the second plate body into contact with a lower surface of the second plate body by approaching the second plate body from below the second plate body; and
causing the roller member to travel in a traveling direction parallel to the lower surface of the second plate body and orthogonal to a rotary shaft of the roller member while pressing the second plate body against the first plate body, wherein
restraining members provided in the respective supports restrict a displacement of the roller member caused by biasing forces, thereby make an upper end of the roller member parallel to the lower surface of the second plate body when the roller member comes into contact with the second plate body.

20. The transfer method according to claim 19, wherein the position of the roller member restricted by the restraining member is adjusted before the roller member comes into contact with the second plate body.
